(19) United States
(12) Patent Application Publication
(10) Pub. No.: US 2015/0354493 A1
(43) Pub. Date: Dec. 10, 2015

(54) ENGINE COMBUSTION ROBUSTNESS CONTROL METHOD BASED ON ENGINE COMBUSTION ESTIMATION AND ENGINE CONTROL SYSTEM FOR ENGINE COMBUSTION ROBUSTNESS

(71) Applicant: Hyundai Motor Company, Seoul (KR)

(72) Inventor: In-Soo JUNG, Suwon-si (KR)

(73) Assignee: Hyundai Motor Company, Seoul (KR)

(21) Appl. No.: 14/531,674

(22) Filed: Nov. 3, 2014

(30) Foreign Application Priority Data
Jun. 9, 2014 (KR) 10-2014-0069320

(51) Int. Cl. F02D 41/40; F02D 41/14

(52) U.S. Cl. CPC F02D 41/401; F02D 41/1401

(57) ABSTRACT

Disclosed are a system and an engine combustion robustness control method based on engine combustion estimation. The method may include setting an MFB50 goal value for controlling a generation position of an MFB50 at which a heat release rate is about 50% in a cylinder during driving of an engine and a Pmax goal value for controlling a maximum pressure formed in the cylinder, detecting vibration of the engine, selecting raw vibration from the detected vibration of the engine, calculating an MFB50 estimation value and a Pmax estimation value by extracting a specific frequency band from the selected raw vibration, adjusting an injection parameter mapping applied to the engine, allowing the MFB50 estimation value to track the MFB50 goal value using an adjusted injection parameter mapping value, and allowing the Pmax estimation value to track the Pmax goal value.

### CROSS-REFERENCE TO RELATED APPLICATIONS

The present application claims priority of Korean Patent Application Number 10-2014-0069320 filed on Jun. 9, 2014, the entire contents of which application are incorporated herein for all purposes by this reference.

### BACKGROUND OF INVENTION

1. Field of Invention

The present invention relates to robustness control for stable combustion in an engine; and, particularly, to a control method and an engine control system for engine combustion robustness, capable of realizing combustion robustness control against disturbances (environments, differences in fuels, engine aging, etc.) without using a high-priced combustion pressure sensor for detecting a combustion pressure in a cylinder during combustion in an engine.

2. Description of Related Art

In general, combustion control is very important in terms of meeting combustion robustness control (e.g., stable combustion and combustion noise control) of an engine under disturbance conditions such as environments, differences in used fuels, and engine aging. This combustion control is more importantly treated in engines (for instance, a diesel engine) having a high compression ratio.

As an example of such engine combustion control, there is a method of using a combustion pressure in a cylinder when an engine is driven. To this end, an engine control system is connected with a combustion pressure sensor installed within the cylinder forming a combustion chamber.

For example, when the engine is driven, an engine RPM, an engine load, a crank angle, or the like is checked from the engine and the combustion pressure sensor directly detects a combustion pressure in the cylinder from the cylinder according to the crank angle for the engine combustion control. Then, a pressure value detected by the combustion pressure sensor is applied to determine an MFB50 (Mass Fraction Burned 50%) at which a heat release rate arising from the combustion pressure is 50%, thereby allowing determination of the crank angle forming the MFB50 to be performed. Subsequently, after a point of the MFB50 is calculated according to an operation state of the engine to be defined as a measured MFB50, the measured MFB50 is compared with a goal MFB50 so that a MFB50 compensation value (goal MFB50−measured MFB50) is calculated using the compared difference value. Thus, the calculated MFB50 compensation value is applied to control a main injection timing of fuel, thereby allowing the main injection timing to be controlled.

As described above, after an MFB50 is calculated using a combustion pressure by the combustion pressure sensor and a crank angle by a crank angle sensor during operation of the engine, the calculated MFB50 is used to control a point of time when a maximum pressure in the cylinder is generated. Therefore, combustion stability and combustion noise control of the engine are stably realized under disturbance conditions such as environments, differences in used fuels, and engine aging.

However, the method of using the combustion pressure to determine the MFB50 and applying the combustion pressure sensor to detect the combustion pressure is an uneconomical method.

A major cause of the uneconomical method is that a high-priced combustion pressure sensor is installed for each cylinder. Furthermore, since a wire layout is also required to establish a system in which a number of combustion pressure sensors are connected to each other, the method may be economically disadvantageous.

In addition, the method of using the combustion pressure detected by the combustion pressure sensor may be disadvantageous since the pressure is measured based on the crank angle to acquire factors necessary for control.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention is directed to an engine combustion robustness control method based on engine combustion estimation and an engine control system for engine combustion robustness, in which a high-priced combustion pressure sensor need not be used for detection of a combustion pressure in a combustion chamber by estimating a generation position of an MFB50 (Mass Fraction Burned 50%)/Pmax (Maximum Cylinder Pressure) from engine vibration generated during combustion, and particularly capable of controlling robustness of an engine under disturbance conditions such as environments, differences in used fuels, and engine aging by adjusting a fuel injection parameter mapping, which sets a calculated MFB50 estimation value/Pmax estimation value as a control factor, from a maximum frequency peak signal extracted from raw vibration of the engine.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with various aspects of the present invention, an engine combustion robustness control method based on engine combustion estimation, includes performing a combustion robustness control setting of setting an MFB50 (Mass Fraction Burned 50%) goal value for controlling a generation position of an MFB50 at which a heat release rate is about 50% in a cylinder during driving of an engine in which combustion is controlled by a controller, and a Pmax goal value for controlling a maximum pressure formed in the cylinder, performing a combustion robustness control preparation of detecting vibration of the engine, selecting raw vibration from the detected vibration of the engine, and calculating an MFB50 estimation value and a Pmax estimation value by extracting a specific frequency band from the selected raw vibration, and performing a combustion robustness control execution of adjusting an injection parameter mapping applied to the engine, allowing the MFB50 estimation value to track the MFB50 goal value using an adjusted injection parameter mapping value, and allowing the Pmax estimation value to track the Pmax goal value.

In the performing of the combustion robustness control setting, when one of the MFB50 goal value and the Pmax goal value is selected as a combustion robustness control setting value, calculation of the MFB50 estimation value, calculation of the Pmax estimation value, tracking control of the MFB50 goal value by the MFB50 estimation value, and tracking control of the Pmax goal value by the Pmax estimation value may be selected according to the selected combustion robustness control setting value.

In the performing of the combustion robustness control setting, the controller may read out data of the engine for setting of the MFB50 goal value and the Pmax goal value, and the data may include an engine RPM, an engine load, a cooling water temperature, an intake air temperature, a fuel injection parameter, a shift level, and an amount of fuel.

In the performing of the combustion robustness control preparation, the raw vibration may be acquired by an acceleration sensor for detecting vibration of the engine, and the acceleration sensor may be mounted outside an engine block of the engine.

In the performing of the combustion robustness control preparation, (A) a signal conversion may be performed to extract the specific frequency band from the selected raw vibration, (B) an ATFP (Average Target Frequency Pattern) having a plurality of local peaks may be acquired by accumulating values of the specific frequency band and then converting the values into an absolute value, (C) a maximum peak may be selected among the plurality of local peaks exhibited at the ATFP and an FVFP (Final Value Frequency Pattern) having the selected maximum peak is acquired, and (D) after an EP_MHRR (Estimation Position Maximum Heat Release Rate) is calculated by applying the maximum peak to an MHRR generation position-peak vibration signal correlation chart, each of the MFB50 estimation value and Pmax estimation value to which the EP_MHRR is applied may be calculated.

In the (A), the signal conversion may be conducted using a wavelet conversion method and/or a filter application method. In the (A), the specific frequency band may be a band of 0.3˜0.8 kHz, 0.6˜0.9 kHz, or 0.3˜1.0 kHz.

In the (B), the accumulating of the values of the specific frequency band may be performed by a method of reading out and accumulating numerical values at intervals of 100 Hz on the basis of the same time.

In the (C), the maximum peak may be a local peak having a maximum peak position among the plurality of local peaks, and the maximum peak position may be determined by reading out and accumulating numerical values of the local peaks at intervals of 100 Hz on the basis of the same time.

In the (D), the MHRR generation position-peak vibration signal correlation chart may be classified into an MHRR generation position-MFB50 generation position correlation chart in which an MFB50-C_MHRR (MFB50-Compensation Maximum Heat Release Rate, MFB50 compensation value) is calculated, and an MHRR generation position-Pmax generation position correlation chart in which a Pmax-C_MHRR (Pmax-Compensation Maximum Heat Release Rate, Pmax compensation value) is calculated, the calculation of the MFB50 estimation value may be confirmed by adding the MFB50-C_MHRR, and the calculation of the Pmax estimation value may be confirmed by adding the Pmax-C_MHRR.

In the performing of the combustion robustness control execution, the adjustment of the injection parameter mapping may be determined by a difference between the MFB50 goal value and the MFB50 estimation value and by a difference between the Pmax goal value and the Pmax estimation value.

The difference between the MFB50 goal value and the MFB50 estimation value may be calculated by subtracting the MFB50 estimation value from the MFB50 goal value, and the difference between the Pmax goal value and the Pmax estimation value may be calculated by subtracting the Pmax estimation value from the Pmax goal value.

In the performing of the combustion robustness control execution, the adjustment of the injection parameter mapping may include a main injection timing and an amount of pilot fuel. The adjustment of the injection parameter mapping may be performed by a PID (Proportion Integration Differential) controller.

In accordance with various other aspects of the present invention, an engine control system for engine combustion robustness, includes a controller for performing combustion robustness control such that stable combustion and combustion noise control are performed when an engine is driven, the controller including an injection parameter mapping portion, a raw vibration processing portion, and an MFB50/Pmax processing portion, wherein the raw vibration processing portion converts raw vibration detected by an acceleration sensor and read as control parameter input data into a wavelet signal to calculate an MHRR (Maximum Heat Release Rate) estimation position value, the MFB50/Pmax processing portion extracts each of an MFB50 estimation position value tracking an MFB50 position goal value for the combustion robustness control and a Pmax estimation position value tracking a Pmax position goal value for the combustion robustness control from the MHRR estimation position value to output the MFB50 position goal value, the Pmax position goal value, the MFB50 estimation position value, and the Pmax estimation position value as control factor extraction data of the controller, and the injection parameter mapping portion reads out the control factor extraction data to adjust an injection parameter mapping output to a PID controller and controls a main injection timing and/or an amount of pilot fuel of the engine by the adjusted injection parameter mapping.

The control parameter input data may include an engine RPM value, an engine load value, a cooling water temperature value, an intake air temperature value, a fuel injection parameter value, a shift level value, and a fuel amount value.

An acceleration sensor for detecting engine vibration may be mounted to an engine block of the engine. The acceleration sensor may be mounted outside the engine block.

The injection parameter mapping portion, the raw vibration processing portion, and the MFB50/Pmax processing portion may be formed integrally with a combustion robustness control module, and the combustion robustness control module may include an MHRR generation position-peak vibration signal correlation chart applied to calculate the MHRR estimation position value, an MHRR generation position-MFB50 generation position correlation chart for compensating the MFB50 estimation position value, and an MHRR generation position-Pmax generation position correlation chart for compensating the Pmax estimation position value.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIGS. 1A and 1B are illustrative flowcharts illustrating an exemplary engine combustion robustness control method based on engine combustion estimation according to the present invention.

FIGS. 2A and 2B are illustrative block diagrams illustrating an exemplary control flow of the engine combustion robustness based on engine combustion estimation according to the present invention.

FIGS. 3A, 3B and 3C are illustrative charts illustrating an exemplary process of calculating an MFB50 (Mass Fraction Burned 50%) estimation value from an MHRR (Maximum Heat Release Rate) position value according to the present invention.

FIGS. 4A, 4B and 4C are views illustrating a configuration of exemplary engine control system to which the engine combustion robustness control according to the present invention is applied.

FIGS. 5A, 5B, and 5C are illustrative views illustrating an MHRR generation position-peak vibration signal correlation chart, an MHRR generation position-MFB50 generation position correlation chart, and an MHRR generation position-Pmax generation position correlation chart provided at a controller of an exemplary engine control system according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

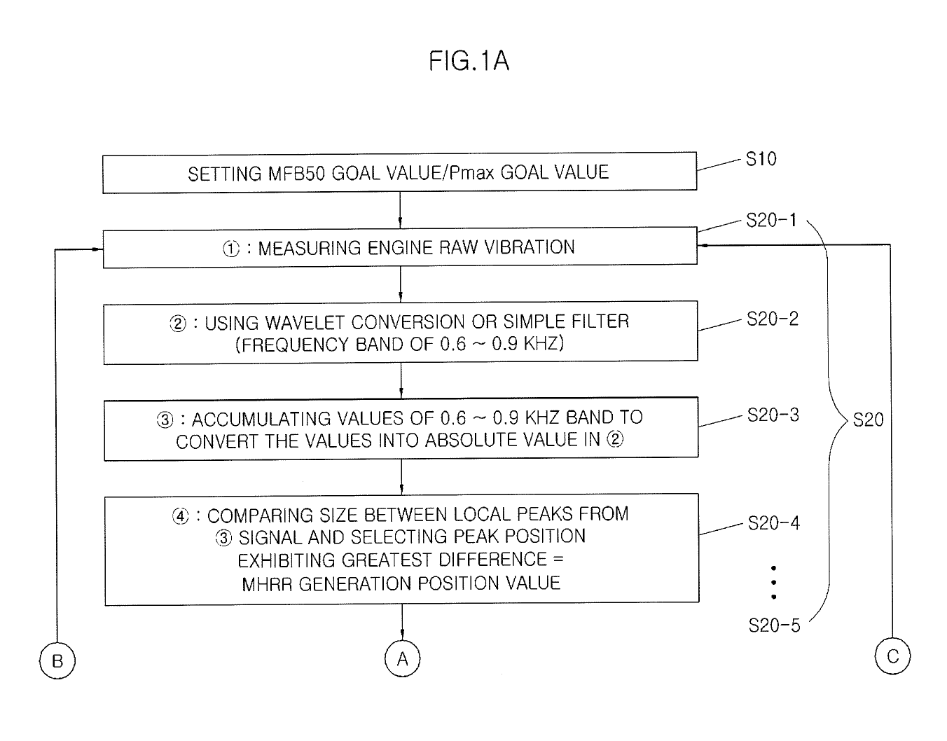

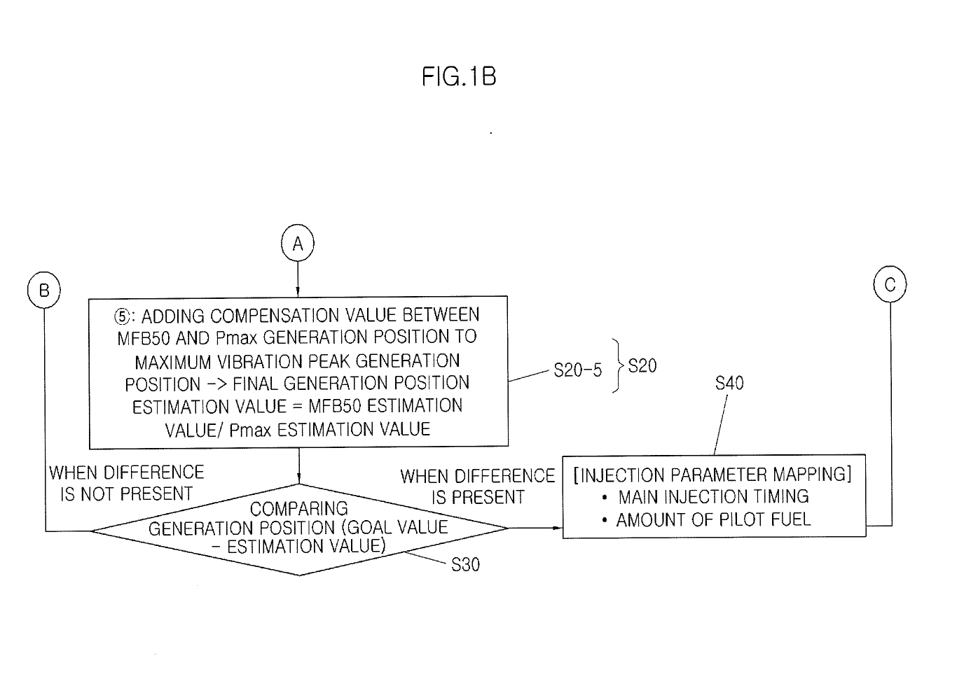

FIGS. 1A, 1B, 2A, 2B, and 3A-3C show a process of controlling engine combustion robustness based on engine combustion estimation according to various embodiments of the present invention. Referring to FIGS. 1A and 1B, an engine combustion robustness control method includes an MFB50 goal value/Pmax goal value setting step at S10, an MHRR generation position estimation step at S20, an MFB50/Pmax comparison step at S30, and an MFB50 goal value/Pmax goal value tracking step at S40. The MFB50 goal value/Pmax goal value setting step S10, the MHRR generation position estimation step S20, the MFB50/Pmax comparison step S30, and the MFB50 goal value/Pmax goal value tracking step S40 are specified as follows.

In the MFB50 goal value/Pmax goal value setting step at S10, goal values such as an MFB50 goal value (Goal Mass Fraction Burned 50%, hereinafter referred to as “G_MFB50”)/Pmax goal value (Goal Maximum Cylinder Pressure, hereinafter referred to as “G_Pmax”) is set to achieve combustion robustness. The MFB50 (Mass Fraction Burned 50%) means that a heat release rate arising from a combustion pressure is 50% or about 50%, and the Pmax means a maximum pressure formed in a cylinder of an engine. Therefore, in the MFB50 goal value/Pmax goal value setting step, the G_MFB50 and the G_MFB50 may be used together or individually.

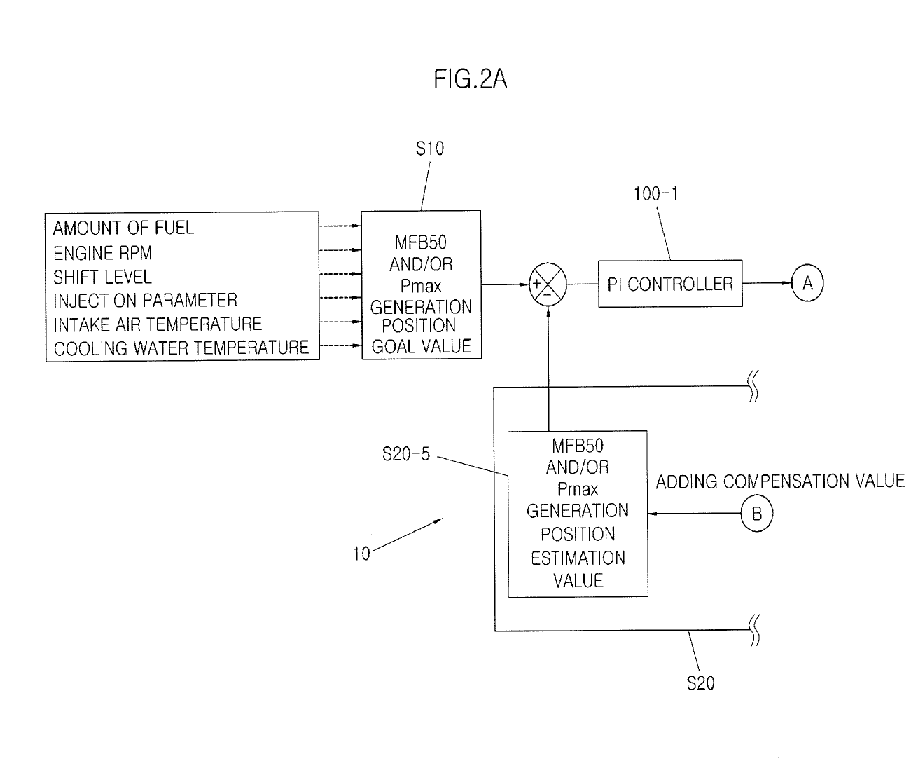

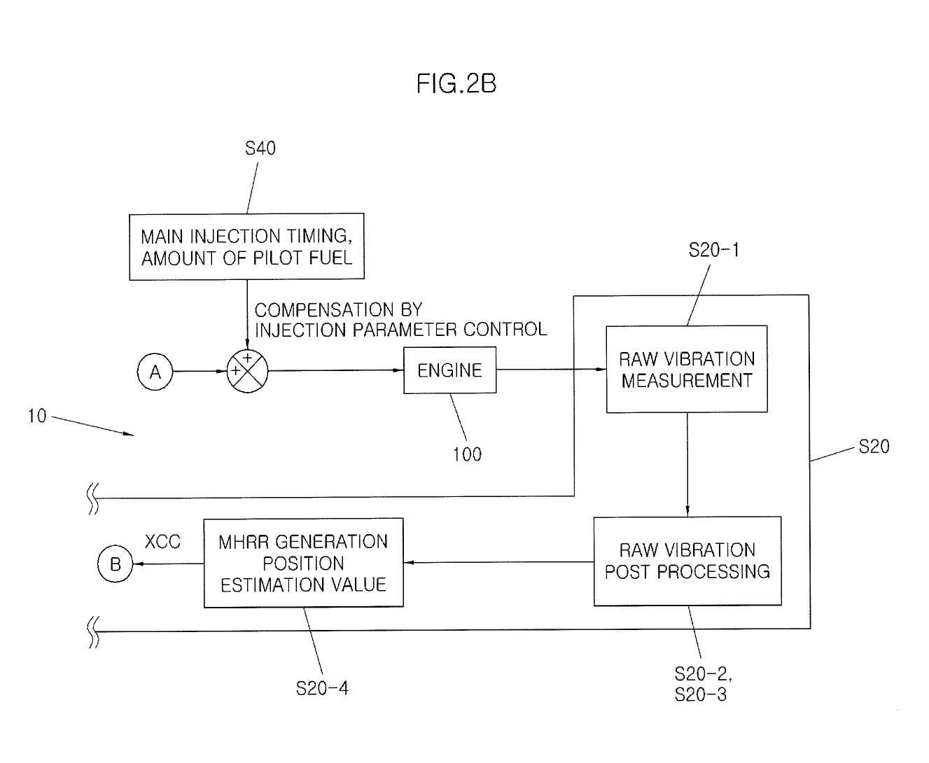

The setting is performed through a plurality of engine detection data measured when an engine is driven and is treated through an MFB50/Pmax generation position S10 of FIGS. 2A and 2B. The engine detection data using the MFB50/Pmax generation position S10 includes an amount of fuel, an engine RPM, a shift level, an intake air temperature, a cooling water temperature, and the like input to a controller 10. The controller 10 determines the MFB50 (Mass Fraction Burned 50%), at which the heat release rate arising from the combustion pressure is 50%, from detected values, thereby allowing the G_MFB50 to be set by reflecting a state of the current driving engine. In addition, the controller 10 determines the Pmax which is a maximum combustion pressure in the cylinder coinciding with the MFB50, thereby allowing the G_Pmax to be set by reflecting a state of the current driving engine.

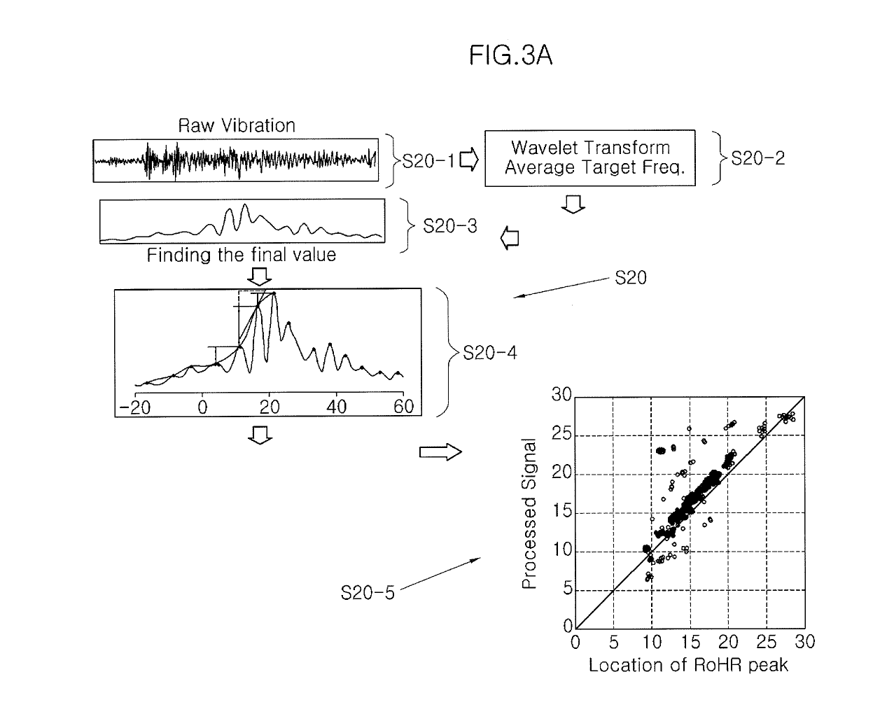

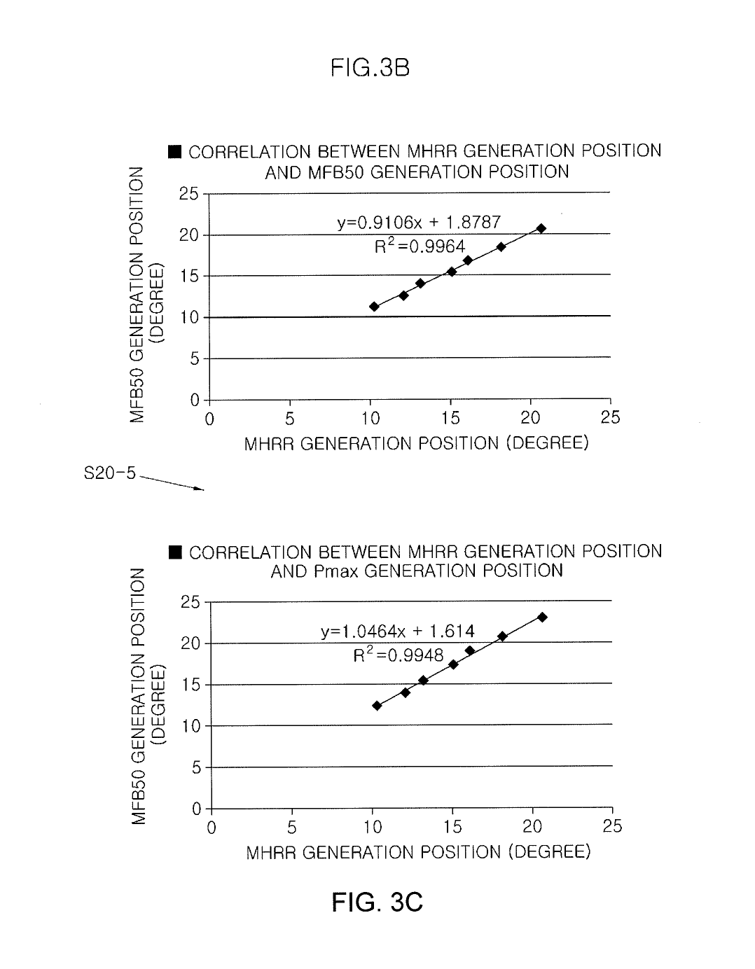

The MHRR generation position estimation step at S20 is a process of estimating 50% of the heat release rate arising from the engine combustion pressure matching the MFB50. An MHRR estimation position value (Estimation Position Maximum Heat Release Rate, hereinafter referred to as “EP_MHRR”) through the MHRR generation position estimation step is applied to calculate an MFB50 estimation value (Estimation Mass Fraction Burned 50%, hereinafter referred to as “E_MFB50”) or a Pmax estimation value (Estimation Maximum Cylinder Pressure, hereinafter referred to as “E_Pmax”). The MHRR generation position estimation step includes steps of S20-1, S20-2, S20-3, S20-4, and S20-5 and is illustrated through FIGS. 2A, 2B, and 3A-3C.

S20-1 is a process of detecting basic data for the EP_MHRR. In such a process, raw vibration of an engine 100 detected by an acceleration sensor mounted outside an engine block is input to raw vibration measurement S20-1 of FIGS. 1A and 2B. As a result, raw vibration such as those illustrated in FIGS. 3A, 3B and 3C is provided or detected. In this case, in the raw vibration S20-1, only a signal detected through a section region from a BTDC (Before Top Dead Center) of 30 degrees to an ATDC (Advanced Top Dead Center) of 60 degrees is used. As such, in the MHRR generation position estimation step, since the raw vibration is detected through the acceleration sensor mounted outside the engine block, the present invention may have an economical advantage compared to a method of detecting a combustion pressure from a high-priced combustion pressure sensor directly installed in the cylinder. Particularly, it may be possible to resolve a disadvantage of measuring a pressure based on a crank angle during detection of the combustion pressure.

S20-2 is a process of converting the raw vibration into a specific frequency band of 0.3˜0.8 kHz. S20-3 is a process of accumulating values of the 0.3˜0.8 kHz band and converting the accumulated values into an absolute value so as to acquire an average target frequency pattern (hereinafter, referred to as “ATFP”) having a maximum peak in the 0.3˜0.8 kHz band. Such a process is treated in raw vibration post processing S20-2, S20-3 of FIGS. 1A and 2B. As a result, the ATFP of FIGS. 3A, 3B and 3C is acquired. To this end, in the specific frequency band conversion, although a wavelet conversion which is a signal processing technology decomposing signals into other partial frequency regions is applied, a simple conversion using a filter may also be applied as necessary. In addition, in the accumulation method for the specific frequency band to perform the absolute value conversion, a method of reading out and accumulating numerical values at intervals of 100 Hz on the basis of the same time is applied. In particular, the specific frequency band is not limited to 0.3˜0.8 kHz. For example, the specific frequency band may be selected as a range of 0.6˜0.9 kHz or 0.3˜1.0 kHz. However, when the specific frequency band is changed, the section region from the BTDC of 30 degrees to the ATDC of 60 degrees tuned into 0.3˜0.8 kHz is changed together.

S20-4 is a process of calculating an EP_MHRR from an ATFP and calculating an MHRR position compensation value (Compensation Maximum Heat Release Rate, hereinafter referred to as “C_MHRR”) applied to the E_MFB50 or the E_Pmax from the calculated EP_MHRR. Such a process is treated in MHRR generation position estimation S20-4 of FIGS. 1A and 2B. For example, the process is a method of selecting local peaks using the ATFP, comparing a size between the selected local peaks, and then checking the local peak exhibiting the greatest difference as a maximum peak position (hereinafter, referred to as “MPP”). In this case, a method of reading out and accumulating numerical values at intervals of 100 Hz on the basis of the same time is applied to the MPP selected from the local peak. As a result, a final value frequency pattern (hereinafter, referred to as “FVFP”) indicated by the MPP such as in FIGS. 3A, 3B and 3C is acquired, and a C_MHRR is determined by applying a result obtained from the FVFP to an MHRR generation position-peak vibration signal correlation chart. The C_MHRR is classified into an MFB50-C_MHRR for the MFB50 estimation value and a Pmax-C_MHRR for the Pmax estimation value. An MHRR generation position-MFB50 generation position correlation chart in which an MFB50 generation position coinciding with the calculated EP_MHRR generation position is found is applied to calculate the MFB50-C_MHRR. In addition, an MHRR generation position-Pmax generation position correlation chart in which a Pmax generation position coinciding with the calculated EP_MHRR generation position is found is applied to calculate the Pmax-C_MHRR.

S20-5 is a process of confirming the MFB50 estimation value or the Pmax estimation value. Such a process is treated in MFB50/Pmax generation position estimation S20-5 of FIGS. 2A and 2B. In the process, the MFB50 estimation value is calculated by only a simple process of adding the MFB50-C_MHRR obtained from the MHRR generation position estimation S20-4, and the Pmax estimation value is calculated by only a simple process of adding the Pmax-C_MHRR.

The MFB50/Pmax comparison step at S30 determines a difference between a theoretical value and an actual value by respectively comparing the MFB50 goal value and the MFB50 estimation value or the Pmax goal value and the Pmax estimation value. To this end, a difference between the MFB50 goal value and the MFB50 estimation value is determined by a relation of MFB50 goal value−MFB50 estimation value and a difference between the Pmax goal value and the Pmax estimation value is determined by a relation of Pmax goal value−Pmax estimation value. As a result, when the difference is not present, the process is returned to S20 so that the MHRR generation position estimation step is performed again. On the other hand, when the difference is present, the process enters the MFB50 goal value/Pmax goal value tracking step at S40.

The MFB50 goal value/Pmax goal value tracking step at S40 is a process of actually performing robustness control of the engine. As illustratively shown in FIGS. 1A and 2B, the process performs combustion control of the engine 100 by a difference between the MFB50 goal value and the MFB50 estimation value or a difference between the Pmax goal value and the Pmax estimation value arising from compensation of a main injection timing/amount of pilot fuel S40 between a PID (Proportion Integration Differential) controller 100-1 and the engine 100. Consequently, control for maintaining robustness of the engine may be realized under disturbance conditions such as environments, differences in used fuels, and engine aging.

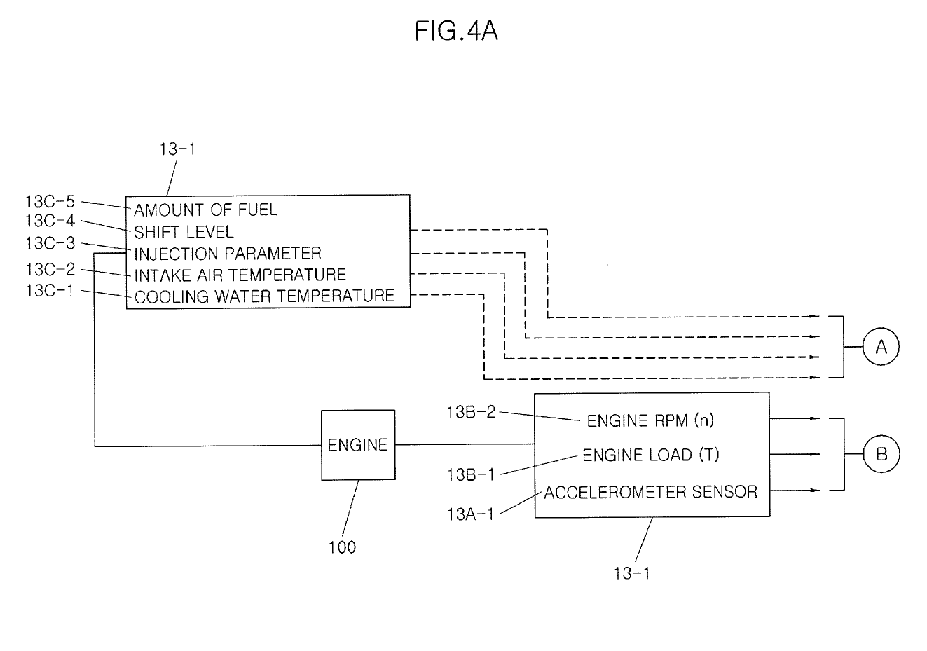

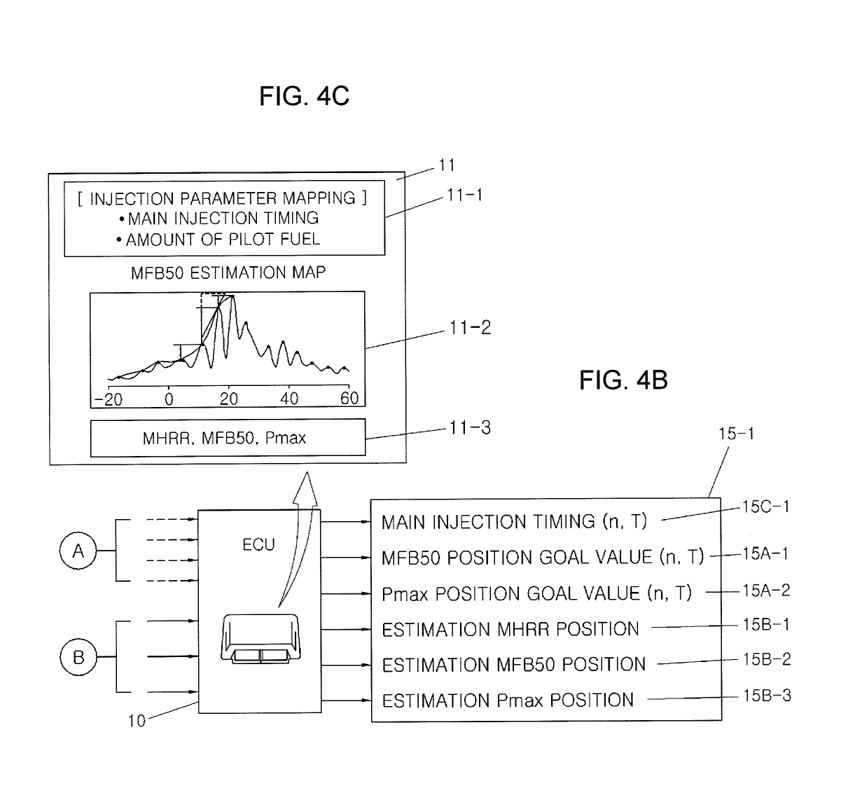

Meanwhile, FIGS. 4A, 4B and 4C show a configuration of the engine control system according to the embodiment of the present invention.

As shown in the drawings, the engine control system includes an engine 100 and a controller 10 which sets an MFB50 goal value/Pmax goal value when the engine 100 is driven, estimates an MHRR generation position using raw vibration of the engine 100, compares an MFB50 estimation value/Pmax estimation value and an MFB50 goal value/Pmax goal value by the estimated MHRR generation position, and compensates a main injection timing/amount of pilot fuel of the engine 100 such that combustion robustness control is performed by tracking the MFB50 goal value/Pmax goal value from the MFB50 estimation value/Pmax estimation value using the compared result. The setting an MFB50 goal value/Pmax goal value, the estimating an MHRR generation position, the comparing an MFB50/Pmax, and the tracking an MFB50 goal value/Pmax goal value are equal to those performed by the MFB50 goal value/Pmax goal value setting step at S10, the MHRR generation position estimation step at S20, the MFB50/Pmax comparison step at S30, and the MFB50 goal value/Pmax goal value tracking step at S40 described through FIGS. 1A-3C. Therefore, the controller 10 refers to a means of processing a combustion robustness control logic of the engine in FIGS. 1A-3C.

In some embodiments, the controller 10 is preferably an ECU (Engine Control Unit or Electric Control Unit). In addition, in some embodiments, the engine 100 is preferably a diesel engine.

Specifically, the controller 10 includes a combustion robustness control module 11 which reads out information generated by the engine 100 as control parameter input data 13-1 and extracts a combustion robustness control factor of the engine 100 as a control factor extraction data 15-1 from the control parameter input data 13-1.

The control parameter input data 13-1 includes an acceleration sensor value 13A-1, an engine RPM value 13B-1, an engine load value 13B-2, a cooling water temperature value 13C-1, an intake air temperature value 13C-2, a fuel injection parameter value 13C-3, a shift level value 13C-4, and a fuel amount value 13C-5. Particularly, the acceleration sensor value 13A-1 means raw vibration detected from the engine 100 by an acceleration sensor mounted outside an engine block of the engine 100, the raw vibration being generated by vibration when the engine 100 is driven.

The control factor extraction data 15-1 includes an MFB50 position goal value 15A-1, a Pmax position goal value 15A-2, an MHRR estimation position value 15B-1, an MFB50 estimation position value 15B-2, a Pmax estimation position value 15B-3, and a main injection timing 15C-1.

The MFB50 position goal value 15A-1 and the Pmax position goal value 15A-2 respectively mean a G_MFB50 (Goal Mass Fraction Burned 50%) and a G_Pmax (Goal Maximum Cylinder Pressure) set in the MFB50 goal value/Pmax goal value setting step S10 of FIGS. 1A and 1B. The MHRR estimation position value 15B-1 means an EP_MHRR (Estimation Position Maximum Heat Release Rate) extracted from an ATFP (Average Target Frequency Pattern) acquired after raw vibration is converted into a wavelet in the MHRR generation position estimation step S20 of FIGS. 1A and 1B. The MFB50 estimation position value 15B-2 means an MFB50 estimation value adding an MFB50-C_MHRR which is a compensation value extracted by applying a C_MHRR (Compensation Maximum Heat Release Rate) obtained by an MPP (Maximum Peak Position) extracted from the ATFP to an MHRR generation position-MFB50 generation position correlation chart. The Pmax estimation position value 15B-3 means a Pmax estimation value adding a Pmax-C_MHRR which is a compensation value extracted by applying a C_MHRR (Compensation Maximum Heat Release Rate) obtained by an MPP (Maximum Peak Position) extracted from the ATFP to an MHRR generation position-Pmax generation position correlation chart. The main injection timing 15C-1 means a fuel injection parameter optimal method classified into a pilot injection, a split injection, a post injection, and a main injection.

To this end, the combustion robustness control module 11 is classified into an injection parameter mapping portion 11-1, a raw vibration processing portion 11-2, and an MFB50/Pmax processing portion 11-3.

The injection parameter mapping portion 11-1 allows combustion of the engine 100 to track the MFB50 position goal value 15A-1 or the Pmax position goal value 15A-2 by controlling output of the PID controller 100-1 by an injection parameter mapping using the control parameter input data 13-1 such as the engine RPM value 13B-1, the engine load value 13B-2, the cooling water temperature value 13C-1, the intake air temperature value 13C-2, the fuel injection parameter value 13C-3, the shift level value 13C-4, and the fuel amount value 13C-5, and the control factor extraction data 15-1 such as the MFB50 position goal value 15A-1/the Pmax position goal value 15A-2, the MFB50 estimation position value 15B-2/the Pmax estimation position value 15B-3, and the main injection timing 15C-1. Consequently, control for maintaining robustness of the engine may be realized under disturbance conditions such as environments, differences in used fuels, and engine aging.

The raw vibration processing portion 11-2 converts raw vibration into a specific frequency band of 0.3˜0.8 kHz using the acceleration sensor value 13A-1 of the control parameter input data 13-1, acquires an ATFP (Average Target Frequency Pattern) by accumulating values of the 0.3˜0.8 kHz band and converting the accumulated values into an absolute value, and acquires an FVFP (Final Value Frequency Pattern) indicated by an MPP (Maximum Peak Position) for extracting the MHRR estimation position value 15B-1 from a maximum peak calculated from the ATFP. To this end, a wavelet or filter conversion is applied to the raw vibration processing portion 11-2, and the raw vibration processing portion 11-2 has a function of reading out and accumulating numerical values at intervals of 100 Hz on the basis of the same time in a specific frequency band such as the 0.3˜0.8 kHz band to convert the accumulated values into an absolute value. In addition, the specific frequency band is not limited to 0.3˜0.8 kHz. For example, the specific frequency band may be selected as a range of 0.6˜0.9 kHz or 0.3˜1.0 kHz.

The MFB50/Pmax processing portion 11-3 calculates an MHRR estimation position value 15B-1 as a FVFP (Final Value Frequency Pattern) which is output of the raw vibration processing portion 11-2, extracts an MFB50 estimation position value 15B-2/a Pmax estimation position value 15B-3 for tracking an MFB50 position goal value 15A-1/a Pmax position goal value 15A-2 from the MHRR estimation position value 15B-1, and provides the MFB50 estimation position value 15B-2/the Pmax estimation position value 15B-3 to the injection parameter mapping portion 11-1.

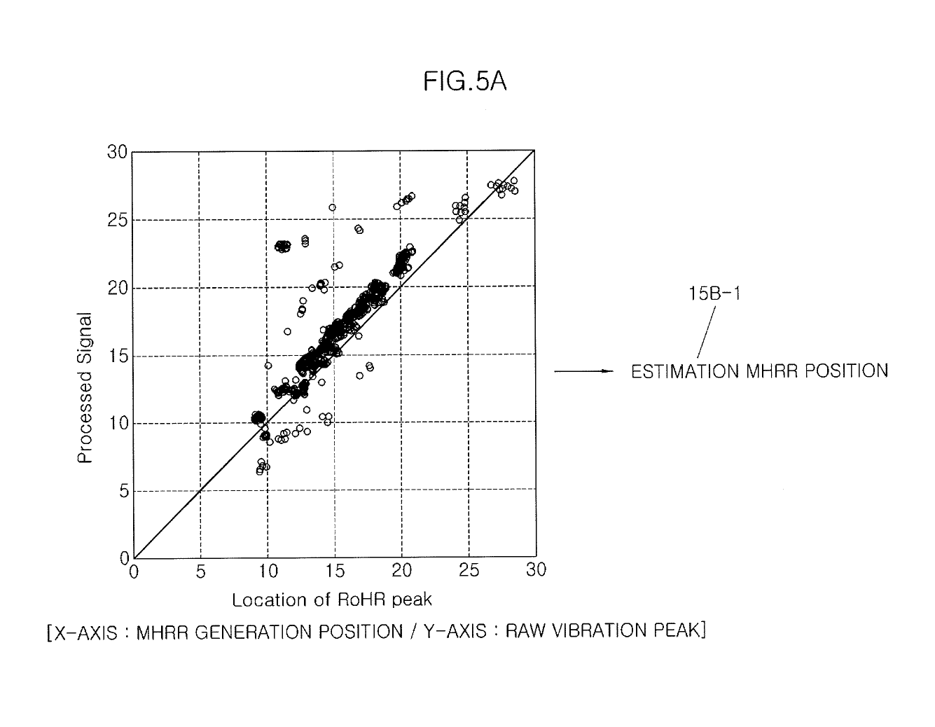

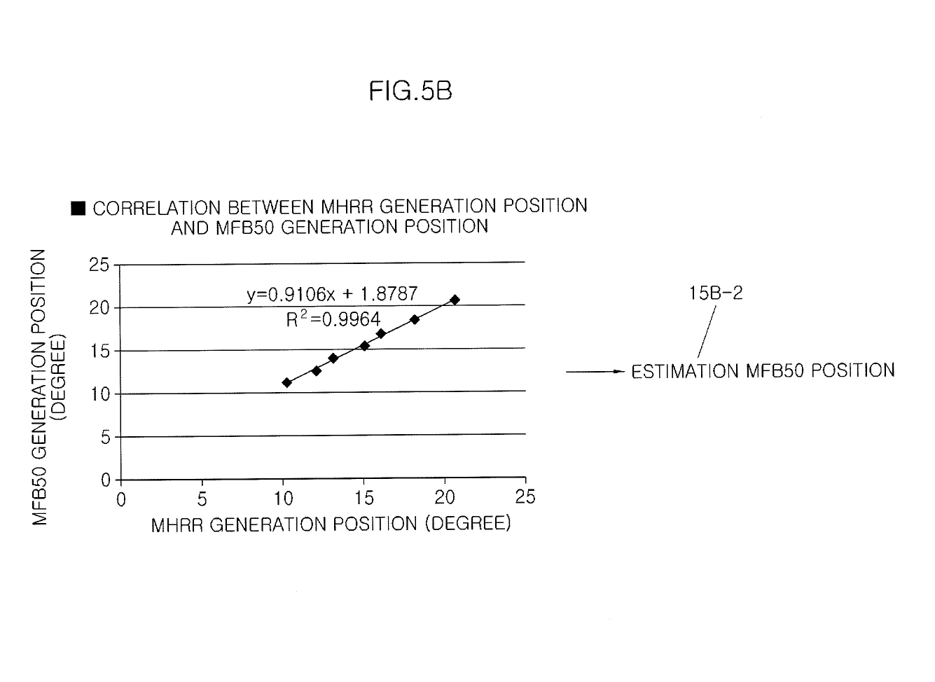

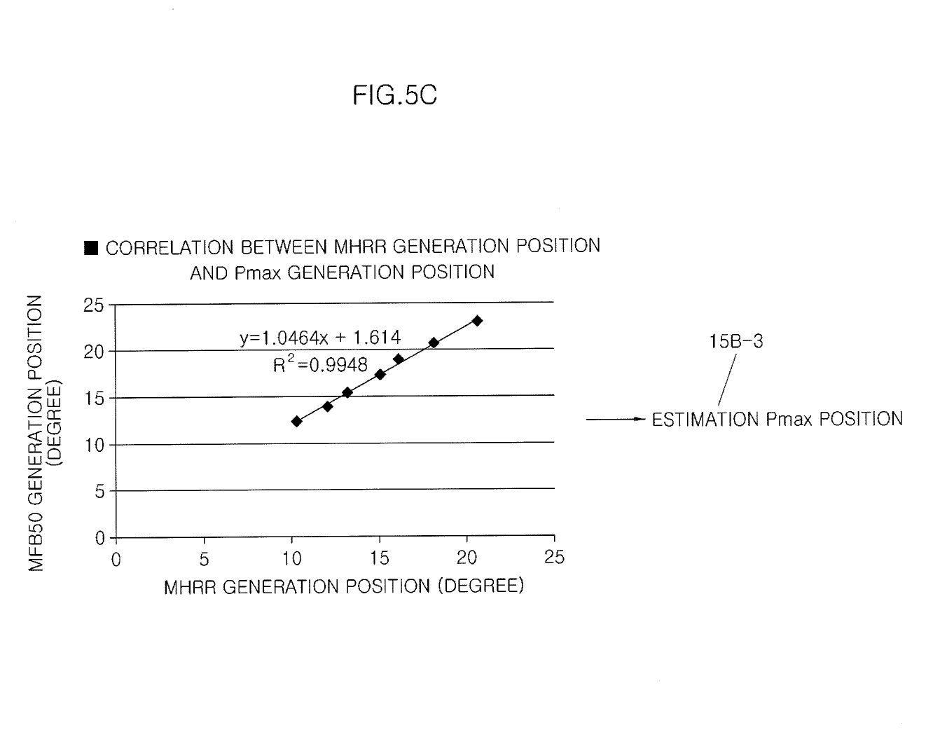

Meanwhile, FIGS. 5A, 5B, and 5C are illustrative views illustrating an MHRR generation position-peak vibration signal correlation chart applied for compensation of the MFB50 estimation position value 15B-2/the Pmax estimation position value 15B-3. The MHRR generation position-peak vibration signal correlation chart is classified into an MHRR generation position-MFB50 generation position correlation chart in which an MFB50-C_MHRR (MFB50-Compensation Maximum Heat Release Rate, MFB50 compensation value) is calculated, and an MHRR generation position-Pmax generation position correlation chart in which a Pmax-C_MHRR (Pmax-Compensation Maximum Heat Release Rate, Pmax compensation value) is calculated. Therefore, the MFB50/Pmax processing portion 11-3 may identify an MHRR (Maximum Heat Release Rate) generation position by raw vibration using the MHRR generation position-peak vibration signal correlation chart, may identify an MFB50 generation position using the MHRR generation position-MFB50 generation position correlation chart, and may identify Pmax generation position using the MHRR generation position-Pmax generation position correlation chart.

As described above, the engine combustion robustness control method based on engine combustion estimation according to various embodiments selects raw vibration detected from the engine 100 during driving of the engine 100 in which combustion is controlled by the controller 10, calculates an MFB50 estimation value and a Pmax estimation value by extracting a specific frequency band from the selected raw vibration, adjusts an injection parameter mapping applied to the engine 100, allows the MFB50 estimation value to track an MFB50 goal value for controlling an MFB50 generation position using the adjusted injection parameter mapping value, and allows the Pmax estimation value to track a Pmax goal value for controlling a maximum pressure formed in a cylinder. Consequently, engine robustness may be controlled under disturbance conditions such as environments, differences in used fuels, and engine aging. Particularly, since a high-priced combustion pressure sensor for detection of a combustion pressure in a combustion chamber is not applied, an engine system for engine combustion robustness control may be established at low costs.

As is apparent from the above description, in accordance with the exemplary embodiments of the present invention, since an MFB50/Pmax is estimated and acquired by an acceleration sensor detecting engine vibration for control of engine combustion robustness, a high-priced combustion pressure sensor is not required. Particularly, by installing an accelerometer sensor outside an engine block, all matters caused by a wire layout by combustion pressure sensors installed at respective cylinders may be wholly resolved.

In addition, since the present invention uses an acceleration sensor cheaper than the high-priced combustion pressure sensor and, particularly, may estimate and acquire the MFB50/Pmax as an engine combustion robustness control factor only using one accelerometer sensor, an engine system for engine combustion robustness control may be established at low costs.

In addition, since the present invention easily selects a specific frequency band for engine combustion robustness control from engine raw vibration measured by the low-priced acceleration sensor and adjusts a fuel injection parameter mapping, which sets an MFB50 estimation value/Pmax estimation value as a control factor, from the selected specific frequency band, it may be possible to promote the practical use of a vibration type engine combustion robustness control remaining at the research level.

In addition, since the present invention uses the acceleration sensor, it may be possible to resolve a disadvantage during application of the combustion pressure sensor requiring measurement of a crank angle reference pressure when the MFB50/Pmax is estimated and acquired.

In addition, the present invention may efficiently perform the engine combustion robustness control under disturbance conditions such as environments, differences in used fuels, and engine aging while an engine vibration method different from a combustion pressure method is applied to the present invention. Particularly, the present invention may be more efficiently applied to a diesel engine requiring the engine combustion robustness control.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An engine combustion robustness control method based on engine combustion estimation, comprising:
performing a combustion robustness control setting of setting an MFB50 (Mass Fraction Burned 50%) goal value for controlling a generation position of an MFB50 at which a heat release rate is about 50% in a cylinder during driving of an engine in which combustion is controlled by a controller, and a Pmax goal value for controlling a maximum pressure formed in the cylinder;
performing a combustion robustness control preparation of detecting vibration of the engine, selecting raw vibration from the detected vibration of the engine, and calculating an MFB50 estimation value and a Pmax estimation value by extracting a specific frequency band from the selected raw vibration; and
performing a combustion robustness control execution of adjusting an injection parameter mapping applied to the engine, allowing the MFB50 estimation value to track the MFB50 goal value using an adjusted injection parameter mapping value, and allowing the Pmax estimation value to track the Pmax goal value.

2. The engine combustion robustness control method of claim 1, wherein, in the performing of the combustion robustness control setting, when one of the MFB50 goal value and the Pmax goal value is selected as a combustion robustness control setting value, calculation of the MFB50 estimation value, calculation of the Pmax estimation value, tracking control of the MFB50 goal value by the MFB50 estimation value, and tracking control of the Pmax goal value by the Pmax estimation value are selected according to the selected combustion robustness control setting value.

3. The engine combustion robustness control method of claim 1, wherein, in the performing of the combustion robustness control setting, the controller reads out data of the engine for setting of the MFB50 goal value and the Pmax goal value, and the data comprises an engine RPM, an engine load, a cooling water temperature, an intake air temperature, a fuel injection parameter, a shift level, and an amount of fuel.

4. The engine combustion robustness control method of claim 1, wherein, in the performing of the combustion robustness control preparation, the raw vibration is acquired by an acceleration sensor for detecting vibration of the engine, and the acceleration sensor is mounted outside an engine block of the engine.

5. The engine combustion robustness control method of claim 1, wherein in the performing of the combustion robustness control preparation:
(A) a signal conversion is performed to extract the specific frequency band from the selected raw vibration,
(B) an ATFP (Average Target Frequency Pattern) having a plurality of local peaks is acquired by accumulating values of the specific frequency band and then converting the values into an absolute value,
(C) a maximum peak is selected among the plurality of local peaks exhibited at the ATFP and an FVFP (Final Value Frequency Pattern) having the selected maximum peak is acquired, and
(D) after an EP_MHRR (Estimation Position Maximum Heat Release Rate) is calculated by applying the maximum peak to an MHRR generation position-peak vibration signal correlation chart, each of the MFB50 estimation value and Pmax estimation value to which the EP_{—} MHRR is applied is calculated.

6. The engine combustion robustness control method of claim 5, wherein, in the (A), the signal conversion is conducted using a wavelet conversion method and/or a filter application method.

7. The engine combustion robustness control method of claim 5, wherein, in the (A), the specific frequency band is a band of 0.3˜0.8 kHz, 0.6˜0.9 kHz, or 0.3˜1.0 kHz.

8. The engine combustion robustness control method of claim 5, wherein, in the (B), the accumulating of the values of the specific frequency band is performed by a method of reading out and accumulating numerical values at intervals of 100 Hz on the basis of the same time.

9. The engine combustion robustness control method of claim 5, wherein, in the (C), the maximum peak is a local peak having a maximum peak position among the plurality of local peaks, and the maximum peak position is determined by reading out and accumulating numerical values of the local peaks at intervals of 100 Hz on the basis of the same time.

10. The engine combustion robustness control method of claim 5, wherein, in the (D), the MHRR generation position-peak vibration signal correlation chart is classified into an MHRR generation position-MFB50 generation position correlation chart in which an MFB50-C_MHRR (MFB50-Compensation Maximum Heat Release Rate, MFB50 compensation value) is calculated, and an MHRR generation position-Pmax generation position correlation chart in which a Pmax-C_MHRR (Pmax-Compensation Maximum Heat Release Rate, Pmax compensation value) is calculated, the calculation of the MFB50 estimation value is confirmed by adding the MFB50-C_MHRR, and the calculation of the Pmax estimation value is confirmed by adding the Pmax-C_MHRR.

11. The engine combustion robustness control method of claim 1, wherein, in the performing of the combustion robustness control execution, the adjustment of the injection parameter mapping is determined by a difference between the MFB50 goal value and the MFB50 estimation value and by a difference between the Pmax goal value and the Pmax estimation value.

12. The engine combustion robustness control method of claim 11, wherein the difference between the MFB50 goal value and the MFB50 estimation value is calculated by subtracting the MFB50 estimation value from the MFB50 goal value, and the difference between the Pmax goal value and the Pmax estimation value is calculated by subtracting the Pmax estimation value from the Pmax goal value.

13. The engine combustion robustness control method of claim 1, wherein, in the performing of the combustion robustness control execution, the adjustment of the injection parameter mapping comprises adjustment of a main injection timing and/or adjustment of an amount of pilot fuel.

14. The engine combustion robustness control method of claim 13, wherein the adjustment of the injection parameter mapping is performed by a PID (Proportion Integration Differential) controller.

15. An engine control system for engine combustion robustness, comprising:
a controller for performing combustion robustness control such that stable combustion and combustion noise control are performed when an engine is driven, the controller comprising an injection parameter mapping portion, a raw vibration processing portion, and an MFB50/Pmax processing portion, wherein
the raw vibration processing portion converts raw vibration detected by an acceleration sensor and read as control parameter input data into a wavelet signal to calculate an MHRR (Maximum Heat Release Rate) estimation position value,
the MFB50/Pmax processing portion extracts each of an MFB50 estimation position value tracking an MFB50 position goal value for the combustion robustness control and a Pmax estimation position value tracking a Pmax position goal value for the combustion robustness control from the MHRR estimation position value to output the MFB50 position goal value, the Pmax position goal value, the MFB50 estimation position value, and the Pmax estimation position value as control factor extraction data of the controller, and
the injection parameter mapping portion reads out the control factor extraction data to adjust an injection parameter mapping output to a PID controller and controls a main injection timing and/or an amount of pilot fuel of the engine by the adjusted injection parameter mapping.

16. The engine control system of claim 15, wherein the control parameter input data comprises an engine RPM value, an engine load value, a cooling water temperature value, an intake air temperature value, a fuel injection parameter value, a shift level value, and a fuel amount value.

17. The engine control system of claim 15, wherein an acceleration sensor for detecting engine vibration is mounted to an engine block of the engine.

18. The engine control system of claim 17, wherein the acceleration sensor is mounted outside the engine block.

19. The engine control system of claim 15, wherein the injection parameter mapping portion, the raw vibration processing portion, and the MFB50/Pmax processing portion are formed integrally with a combustion robustness control module, and the combustion robustness control module comprises an MHRR generation position-peak vibration signal correlation chart applied to calculate the MHRR estimation position value, an MHRR generation position-MFB50 generation position correlation chart for compensating the MFB50 estimation position value, and an MHRR generation position-Pmax generation position correlation chart for compensating the Pmax estimation position value.

20. The engine control system of claim 15, wherein the engine is a diesel engine and the controller is an ECU (Engine Control Unit).
